(19) United States
(12) Patent Application Publication
(10) Pub. No.: US 2005/0259001 A1
(43) Pub. Date: Nov. 24, 2005

(54) Extended global radiolocalization system

(76) Inventor: Gines Sanchez Gomez, Mostoles (ES)

Correspondence Address: Gines SANCHEZ GOMEZ, Calle Cervantes, 1, 7, B, Mostoles, 28932, ES

(21) Appl. No.: 10/957,155

(22) Filed: Oct. 4, 2004

Related U.S. Application Data
(63) Continuation-in-part of application No. 10/446,479, filed on May 23, 2003.

(30) Foreign Application Priority Data
Dec. 2, 2003 (ES) P200302894

(51) Int. Cl. H04B 1/06

(52) U.S. Cl. 342/357.01

(57) ABSTRACT

Extended global radiolocalization system regarding the U.S. Ser. No. 10/446,479 application, by means of asynchronic sampling of radiolocalization signals from repeater satellites through edge sensitive circuit, each satellite having the same or different emission frequency than other satellites of the system.

### CROSS-REFERENCE TO RELATED APPLICATIONS

The present invention is based in the Spanish application for patent no. P200302894 dated Dec. 2, 2003, that is priority. Also the invention is an extended application regarding the U.S. Ser. No. 10/446,479 patent application.

### BACKGROUND OF THE INVENTION

The sujet matter of the prior application US Ser. No. 10/446,479 is extended for permitting the use of the radiolocalization system for several private operators.

### BRIEF SUMMARY OF THE INVENTION

A radiolocalization signal F has the following fields:
IE emission identifier,
IT emitter geography coordinates,
T emitter local time,
RS emitter delay of synchronization,
IR emission delay.

It is possible which all or some satellites j can be radiorepeater of a signal Fjt from a terrestrial radiostation t. In this case, the terrestrial radiostation sends the satellite the fields IE, . . . IR, according the next:
ΔT: transit time of the radiolocalization signal from the terrestrial radiostation t to the satellite radiorepeater j,
Rj(T): function to obtain the satellite position j at the time T,
ΔT is calculated according to:
   |Rj(Tt+ΔT)−ITt|=c*ΔT
the fields IT y T are calculated according to:
   ITj=Rj(Tt+ΔT)
   Tj=Tt+ΔT.
Tt is the anticipated emitter time into the terrestrial radiostation.

The time is from a pulse clock being TT its period, while the signals are binary, being the sampling period TM and TT<<TM.

When a satellite repeats a terrestrial signal from a terrestrial radiostation, said terrestrial radiostation would be synchronized itself with its own repeated signals through the satellite, correcting in real time the ionosphere and troposphere delays.

The terrestrial radiostation may be sinchronized with the radiolocalization signal from the satellites or with synchronizing signals from another terrestrian radiostation, in this last case, the synchronizing signals are also radiolocalization signal, and so would be used.

The previous paragraph permits to use comunication and television satellites for radiolocalization, and by this that also private enterprises can supply radiolocalization signals, using different emission identifier IE for each enterprise or spacial agency. By this, each operator would be provided with very few frequencies, and each operator would use different TM and TT. In this case, the system must be changed according the following:
adding a field TT to the radiolocalization signal, being said TT the value in seconds of one unity of T, RS et IR, being the global emission time of a signal (T+RS+IR).TT,
adding a field CA to the radiolocalization signal, being said CA a checking field, being a known function of the rest of the fields,
the field IE including the bits 010 or 101 at the start or at the end of said IE, for measuring TM,
for obtaining the local RSj or the coordinates of a mobile X, the signals are received at j or x in a wide bandwidth or multifrequency,
by previous each received signal is the addition of several radiolocalization signals
the received signals at j or x are sampled in asyncrhonic mode, through edge sensitive circuits,
when a edge is detected, a sampling record is generated, containing the local time and the edge type (up edge or down edge),
the local time are pulses of period TTT<<(any TM), said TTT would be different from the clock pulses TT of each radiostation,
the time TTT is from the clock of a computer,
the sampling records may be in the receiver circuit or in the computer,
the minimal number of said sampling records is
   (length of the signal IE+ . . . +IR+CA=nF)*(number of radiolocalization signals received at a time=nf)*2
   alternatively, if all the TM are know, the minimal time interval is max(TM).nF.2.

The computer of j or x, according the sampling records obtains the radiolocalization signals:
the set of the sampling records are stored in an array MRM(len=n*nF*2=nMRM), being |MRM(1)|<|MRM(2)|< . . . <|MRM(nMRM)|,
the sign of each MRM(I)+if an up edge,
the sign of each MRM(I)−if a down edge,
for each I, J, J>I, being MRM(I)*MRM(J)<0 (<> sign), the computer calculates the differents and possibles TMIJ=|MRM(J)|−|MRM(I)|,
the computer chooses the k1, k2, . . . , kr, . . . , being |(MRM(kr)−MRM(I))|/TMIJ an integer number (o very near to an integer number), defining the sets KIJ,
the computer selects subsets L {l1, . . . ls, . .. } of KIJ, said Is in the order of KIJ, being MRM(ls)*MRM(ls+1)<0,
for each subsets L, if MRM(l1)>0, the computer obtains a signal F: consecutively |(MRM(l2)−MRM(l1))|/TMIJ ones, consecutively |(MRM(3)−MRM(l2))|/TMIJ zeros, . . . ,
if said F contains one valid field IE and the followign bits are coherent with the checking field CA, the radiolocalization signal Fi has been obtained.

### BRIEF DESCRIPTION OF THE FIGURES

FIG. 1. Signals from the radiolocalization system for radiorepeater satellites.

FIG. 2. Formation signal circuit.

FIG. 3. The formation signal circuit when the satellites are radiorepeaters.

FIG. 4. Computer controlled asyncrhonic sampling.

FIG. 5. Example of mixing three signals.

FIG. 6. Computerized process of mixed signals.

### DETAILED DESCRIPTION OF THE INVENTION AND FIGURES

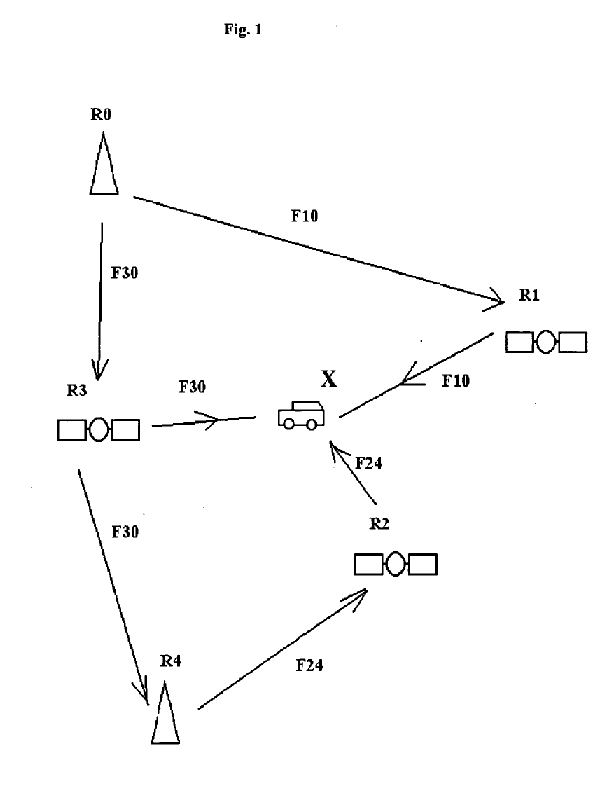

FIG. 1. Signals from the radiolocalization system for radiorepeater satellites.

This figure shows the terrestrial radiostation R0 feeding the satellites R1 and R3 with the signals F10 and F30, while the satellite R3 synchronizes the terrestrial radiostation R4 with the repeater signal F30.

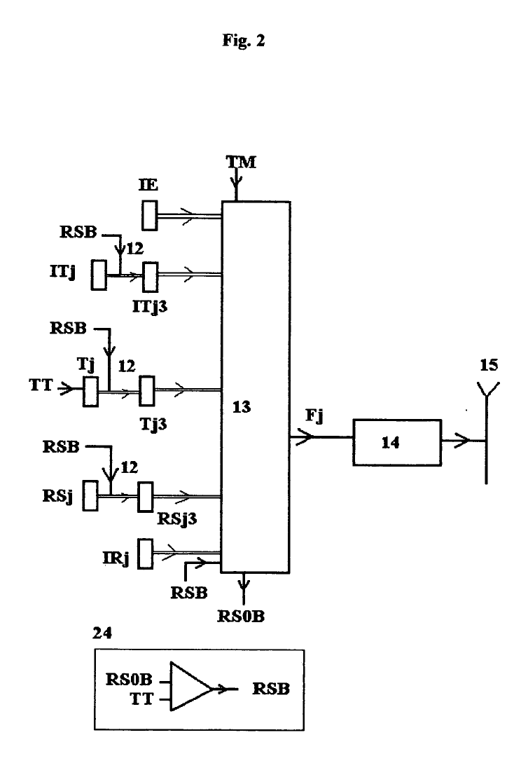

FIG. 2. Formation signal circuit.

The satellite j emits the signal Fj through a modulator 14 and an emitter 15, being obtained Fj from the sequencer 13.

A signal RS0B from said sequencer 13 informs that the system is ready to send a new set of data, being changed this signal RS0b in a pulse RSB through the circuit 24. This pulse RSB fixes the record Tj, ITj y RSj on the record Tj3, ITj3 and RSj3 by mean of the 12, each Tj3, ITj3 and RSj3 is constant until new pulse RSB.

The pulse RSB also starting the sequencer 13, beginning to transform the parallel record IE, ITj3, Tj3, RSj3 and IRj into the serial signal Fj.

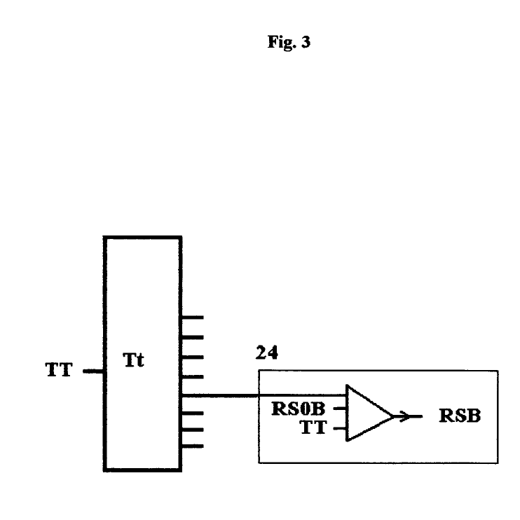

FIG. 3. The formation signal circuit when the satellites are radiorepeaters. The door AND of the circuit 24 from FIG. 2 is provided with another input for avoiding the signal RSB till the devices ITj, Tj and RSj from FIG. 2 before the system calculates the ecuations:
|Rj(Tt+ΔTt+ΔT)−ITt|=c*ΔT
ITj=Rj(Tt+ΔTt+ΔT)
Tj=Tt+ΔTt+ΔT
before the time Tt+ΔTt.

This new input is the e1 bit p from a counter Tt, which is actuated by TT, so the devices ITj, Tj and RSj from FIG. 2 have for calculating the time interval
ΔTt=2^{p-1}×TT×2.

This new performance is a synchronizing circuit.

Naturally, the devices ITj, Tj and RSj start with the signal RSB.

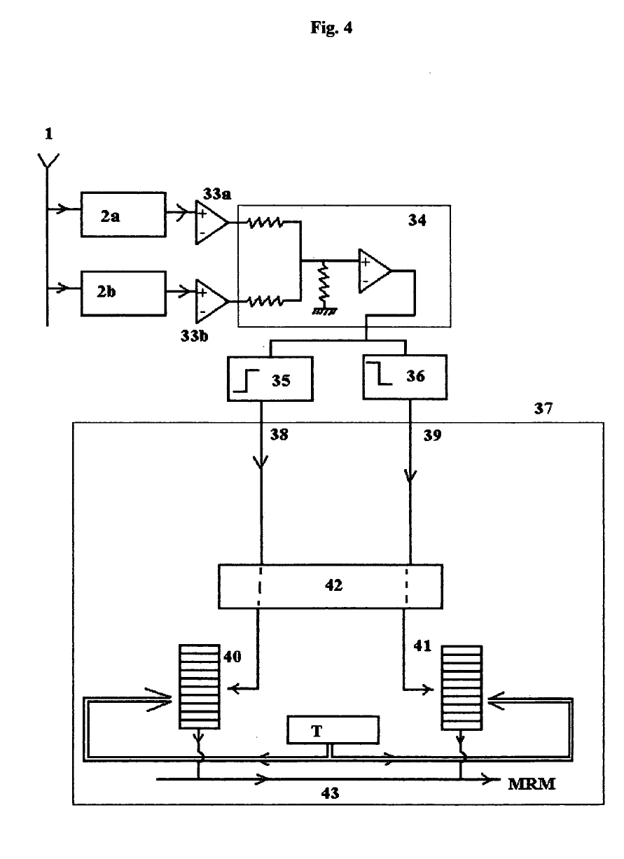

FIG. 4. Computer controlled asyncrhonic sampling.

The demoduler 2a receives signals of frequency f1, while the demoduler 2b receives a bandwidth f2-f3. The amplifiers 33 and 34 fit the signals from the demodulers, said signals being merged in 34.

When the signal from 34 has an up edge, a sensitive up edge circuit 35 sends a pulse to the computer 37 through the serial port 38, said serial port controlled by an interruption 42, said interruption copies the time record T of the computer to a memory address 40 controlled by said interruption.

When the signal from 34 has an down edge, a sensitive down edge circuit 36 sends a pulse to the computer 37 through the serial port 39, said serial port controlled by an interruption 42, said interruption copies the time record T of the computer to a memory address 41 controlled by said interruption.

When nF*nf*2 records have been memorized, the computer creates the array MRM containing the values of said records, starting the receiving cycle again.

The speed of the port 38 and 39 must be about 1/TTT, while the interruption 42 must be highly priority.

The sensitive edge circuits may for example adapted differential circuits, followed by and an amplifier, a diode and a limiter.

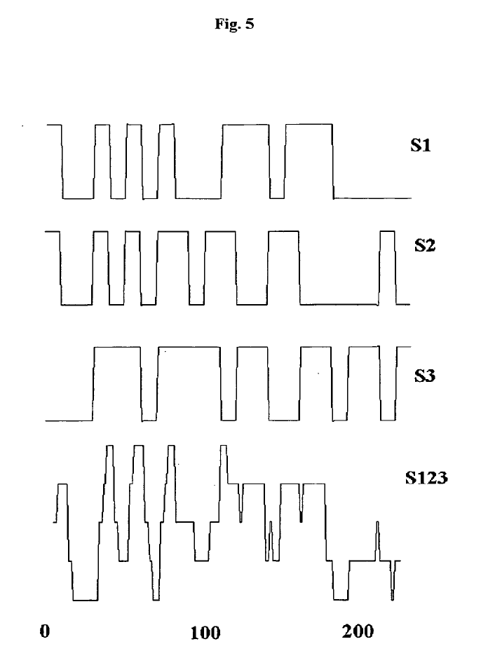

FIG. 5. Example of mixing three signals.

The FIG. 5 shows three signals S1, S2, S3, two of said signals having the same emission identifier 10010, and the other with the emission identifier 00011. The three signals having a length of 23 bits.

Also the FIG. 5 shows the addition of the three signals S123, being the first signal amplified a factor 1, the second signal amplified a factor 0.5 and delayed 5 TTT, and the third amplified a factor 0.5 and delayed 7 TTT.

From said signal S123 the computer obtain the array MRM {1, 4, −11, −14, 31, 34, 36, −41, 44, 51, 54, −61, −64, −66, 71, 74, 76, −81, −94, 104, 111, −116, −124, 124, −141, 144, −146, 151, −164, 166, −181, −186, 196, 214, −216, −224, 226, 231, 234, −236}

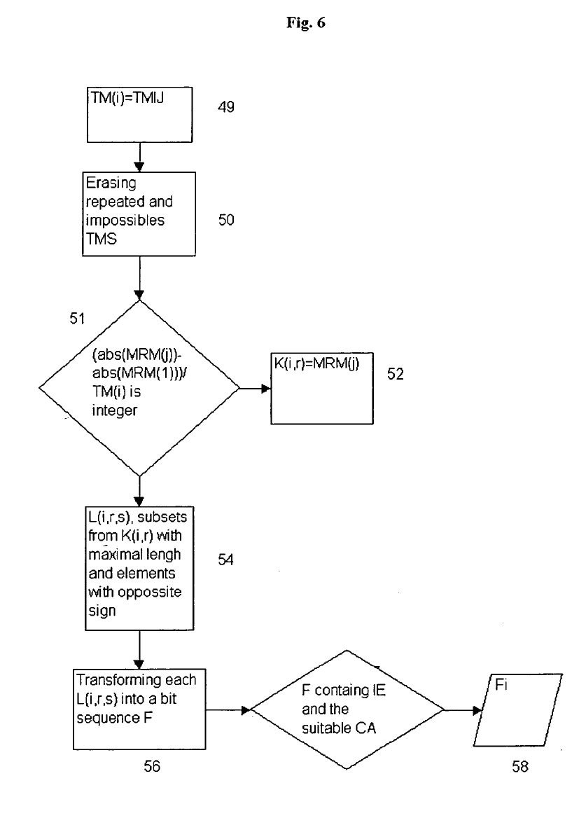

FIG. 6. Computerized process of mixed signals.

The process 49 calculates all the possible TMs, having in account that one TMIJ is not valid if (|MRM(nMRM)|−|MRM(1)|)/TMIJ<nF. So, the following TMs are obtained TM {3, 10, 7, 5, 2, 8}.

The process 50 reduces the number of TM, for example having in account only the possible TMs of the radiolocalization signals supplier, also in this case must be deleted TM=2 or 3, because TM*TTT does not >>TT. So, TM {10}

For each TM(i), the processes 51 and 52 obtain one edge set K(i,r). Being TM(1)=10:
K(1){1, −11, 31, −41, 51, −61, 71, −81, 111, −141, −151, −181, 231}

The process 54 obtains the subsets L(i,r,s) of K(i,r). In this case, there are one subset L(1,1), with the same elements that K(1).

The process 56 changes said L(1,1)={1, −11, 31, −41, 51, −61, 71, −81, 111, −141, −151, −181, 231} into the bit sequence:

| | |
|---|---|
| (11-1)/10 = 1 | 1 bits value 1 |
| (31-11)/10 = 2 | 2 bits value 0 |
| (41-31)/10 = 1 | 1 bits value 1 |
| (51-41)/10 = 1 | 1 bits value 0 |
| (61-51)/10 = 1 | 1 bits value 1 |
| . . . | |
| => 100101 . . . | |

The processes 57 and 58 obtain one radiolocalization senal from said bit sequence.

1. A method for the radiolocalization of a mobile, receiving the mobile some radiolocalization signals from at least three visible satellites, each signal containing the position and the time of the emitter satellite, each signal being a binary signal and the time are from a pulse clock comprising
sampling or sequencing each radiolocalilation signal with a pulse sampling signal, the sampling signal period bigger than the clock period,
identifying each radiolocalization signal by means of a common emission identifier field being its two last bits 10, or alternatively identifying each radiolocalization signal by means of a supplier emission identifier field being its three last bits or the three first bit 010 or 101.

2. The method of the claim 1 when the satellite radiostation is a repeater circuit which repeats a radiolocalization signal from a terrestrial radiostation, while the terrestrial radiostation calculates the data of said radiolocalization signal at the time of the repetition by the satellite, comprising synchronizing said terrestrial radiostation itself with the repeated signal.

3. The method of the claim 1 when the two last bits of the common emission identifier field are 10, comprising
synchronical sampling of the radiolocalization signal, being the periods of said sampling and clock signal the same in all the system,
modulating the radiolocalization signal the satellites or terrestrias radiostations with a different frenquency only when the reception zones of the satellites or terrestrial radiostations have common points.

4. The method of the claim 1 when the three last bits or the three first bit of the common emission identifier field are 010 or 101, comprising
sampling or sequencing each radiolocalization signal with a pulse sampling signal, the sampling signal period bigger that the clock period, the periods of said sampling and clock signal may be different in each satellite or radiostation of the system, and being asynchronic the sampling of the radiolocalization signall,
modulating the radiolocalization signal the satellites or terrestrial radiostations with a same or different frequency,
receiving the radiolocalization signals in multifrequency or in wide bandwidths,
sampling by edge detection, recording the edge time and if the edge is up or down,
obtaining the radiolocalization signals by computing the edge time.

5. A system for the radiolocalization of a mobile, the mobile receiving modulated radiolocalization signals from at least three visible satellites, the mobile and each satellite provided with a radiostation, each signal containing the position and the time of the emitter satellite, each signal defining a surface or line where the mobile would be located, comprising
a pulse sampling signal and a pulse clock signal, the sampling signal period bigger than the pulse clock period,
the periods of the sampling and clock signals may be different in the satellites and terrestrial radiostations of the system,
a supplier emission identifier field being the three last or first bits 010 or 101,
the radiolocalization signal having a period field containing the value in seconds of the pulses of the clock signal,
the radiolocalization signal containing a checking field,
multidemoduler and/or wide bandwidth demoduler, and a merging circuit for the signal from said demodulers,
edge sensitive circuits for up edge and down edge,
cricuits for measuring and storing the time of said edges,
means for computing the up edge and down edge times, obtaining the radiolocalization signal.

6. The system of the claim 5 when the satellite radiostation is a repeater circuit characterized in having terrestrial radiostations, each terrestrial radiostation with a synchronizing circuit for emitting the radiolocalization signal at the correct time.

7. The radiolocalization system of the claim 5 comprising
each edge sensitive circuits being connected to a computer by mean of a serial port,
said serial ports controlled by a computer interruption,
said interruption being programmed to storing into the computer memory an edge detection time when a edge sensitive circuit is actuated,
a program computer to process the edge detection times.
